(19) United States
(12) Patent Application Publication
(10) Pub. No.: US 2018/0211668 A1
(43) Pub. Date: Jul. 26, 2018

(54) REDUCED LATENCY SPEECH RECOGNITION SYSTEM USING MULTIPLE RECOGNIZERS

(71) Applicant: Nuance Communications, Inc., Burlington, MA (US)

(72) Inventors: Daniel WILLETT, Walluf (DE); Christian GOLLAN, Saarbrücken (DE); Carl Benjamin QUILLEN, Aachen (DE); Stefan HAHN, Köln (DE); Fabian STEMMER, Aachen (DE)

(73) Assignee: Nuance Communications, Inc., Burlington, MA (US)

(21) Appl. No.: 15/745,523

(22) PCT Filed: Jul. 17, 2015
(86) PCT No.: PCT/US15/40905

§ 371 Date: Jan. 17, 2018

(51) Int. Cl. G10L 15/30

(52) U.S. Cl. CPC G10L 15/30; G10L 2015/221

(57) ABSTRACT

Method and apparatus for providing visual feedback on an electronic device in a client/server speech recognition system comprising the electronic device and a network device remotely located from the electronic device. The method comprises processing, by an embedded speech recognizer of the electronic device, at least a portion of input audio comprising speech to produce local recognized speech, sending at least a portion of the input audio to the network device for remote speech recognition, and displaying, on a user interface of the electronic device, visual feedback based on at least a portion of the local recognized speech prior to receiving streaming recognition results from the network device.

### BACKGROUND

Some electronic devices, such as smartphones, tablet computers, and televisions include or are configured to utilize speech recognition capabilities that enable users to access functionality of the device via speech input. Input audio including speech received by the electronic device is processed by an automatic speech recognition (ASR) system, which converts the input audio to recognized text. The recognized text may be interpreted by, for example, a natural language understanding (NLU) engine, to perform one or more actions that control some aspect of the device. For example, an NLU result may be provided to a virtual agent or virtual assistant application executing on the device to assist a user in performing functions such as searching for content on a network (e.g., the Internet) and interfacing with other applications by interpreting the NLU result. Speech input may also be used to interface with other applications on the device, such as dictation and text-based messaging applications. The addition of voice control as a separate input interface provides users with more flexible communication options when using electronic devices and reduces the reliance on other input devices such as mini keyboards and touch screens that may be more cumbersome to use in particular situations.

### SUMMARY

Some embodiments are directed to an electronic device for use in a client/server speech recognition system comprising the electronic device and a network device remotely located from the electronic device. The electronic device comprises an input interface configured to receive input audio comprising speech, an embedded speech recognizer configured to process at least a portion of the input audio to produce local recognized speech, a network interface configured to send at least a portion of the input audio to the network device for remote speech recognition, and a user interface configured to display visual feedback based on at least a portion of the local recognized speech prior to receiving streaming recognition results from the network device.

Other embodiments are directed to a method of providing visual feedback on an electronic device in a client/server speech recognition system comprising the electronic device and a network device remotely located from the electronic device. The method comprises processing, by an embedded speech recognizer of the electronic device, at least a portion of input audio comprising speech to produce local recognized speech, sending at least a portion of the input audio to the network device for remote speech recognition, and displaying, on a user interface of the electronic device, visual feedback based on at least a portion of the local recognized speech prior to receiving streaming recognition results from the network device.

Other embodiments are directed to a non-transitory computer-readable medium encoded with a plurality of instructions that, when executed by at least one computer processor of an electronic device in a client/server speech recognition system comprising the electronic device and a network device remotely located from the electronic device, perform a method. The method comprises processing, by an embedded speech recognizer of the electronic device, at least a portion of input audio comprising speech to produce local recognized speech, sending at least a portion of the input audio to the network device for remote speech recognition, displaying, on a user interface of the electronic device, visual feedback based on at least a portion of the local recognized speech prior to receiving streaming recognition results from the network device.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a client/server architecture in accordance with some embodiments of the invention; and

FIG. 2 is a flowchart of a process for providing visual feedback for speech recognition on an electronic device in accordance with some embodiments.

### DETAILED DESCRIPTION

When a speech-enabled electronic device receives input audio comprising speech from a user, an ASR engine is often used to process the input audio to determine what the user has said. Some electronic devices may include an embedded ASR engine that performs speech recognition locally on the device. Due to the limitations (e.g., limited processing power and/or memory storage) of some electronic devices, ASR of user utterances often is performed remotely from the device (e.g., by one or more network-connected servers). Speech recognition processing by one or more network-connected servers is often colloquially referred to as “cloud ASR.” The larger memory and/or processing resources often associated with server ASR implementations may facilitate speech recognition by providing a larger dictionary of words that may be recognized and/or by using more complex speech recognition models and deeper search than can be implemented on the local device.

Hybrid ASR systems include speech recognition processing by both an embedded or “client” ASR engine of an electronic device and one or more remote or “server” ASR engines performing cloud ASR processing. Hybrid ASR systems attempt to take advantage of the respective strengths of local and remote ASR processing. For example, ASR results output from client ASR processing are available on the electronic device quickly because network and processing delays introduced by server-based ASR implementations are not incurred. Conversely, the accuracy of ASR results output from server ASR processing may, in general, be higher than the accuracy for ASR results output from client ASR processing due, for example, to the larger vocabularies, the larger computational power, and/or complex language models often available to server ASR engines, as discussed above. In certain circumstances, the benefits of server ASR may be offset by the fact that the audio and the ASR results must be transmitted (e.g., over a network) which may cause speech recognition delays at the device and/or degrade the quality of the audio signal. Such a hybrid speech recognition system may provide accurate results in a more timely manner than either an embedded or server ASR system when used independently.

Some applications on an electronic device provide visual feedback on a user interface of the electronic device in response to receiving input audio to inform the user that speech recognition processing of the input audio is occurring. For example, as input audio is being recognized, streaming output comprising ASR results for the input audio received and processed by an ASR engine may be displayed on a user interface. The visual feedback may be provided as “streaming output” corresponding to a best partial hypothesis identified by the ASR engine. The inventors have recognized and appreciated that the timing of presenting the visual feedback to users of speech-enabled electronic devices impacts how the user generally perceives the quality of the speech recognition capabilities of the device. For example, if there is a substantial delay from when the user begins speaking until the first word or words of the visual feedback appears on the user interface, the user may think that the system is not working or unresponsive, that their device is not in a listening mode, that their device or network connection is slow, or any combination thereof. Variability in the timing of presenting the visual feedback may also detract from the user experience.

Providing visual feedback with low latency and non-variable latency is particular challenging in server-based ASR implementations, which necessarily introduce delays in providing speech recognition results to a client device. Consequently, streaming output based on the speech recognition results received from a server ASR engine and provided as visual feedback on a client device is also delayed. Server ASR implementations typically introduce several types of delays that contribute to the overall delay in providing streaming output to a client device during speech recognition. For example, an initial delay may occur when the client device first issues a request to a server ASR engine to perform speech recognition. In addition to the time it takes to establish the network connection, other delays may result from server activities such as selection and loading of a user-specific profile for a user of the client device to use in speech recognition.

When a server ASR implementation with streaming output is used, the initial delay may manifest as a delay in presenting the first word or words of the visual feedback on the client device. As discussed above, during the delay in which visual feedback is not provided, the user may think that the device is not working properly or that the network connection is slow, thereby detracting from the user experience. As discussed in further detail below, some embodiments are directed to a hybrid ASR system (also referred to herein as a “client/server ASR system,”) where initial ASR results from the client recognizer are used to provide visual feedback prior to receiving ASR results from the server recognizer. Reducing the latency in presenting visual feedback to the user in this manner may improve the user experience, as the user may perceive the processing as happening nearly instantaneously after speech input is provided, even when there is some delay introduced through the use of server-based ASR.

After a network connection has been established with a server ASR engine, additional delays resulting from the transfer of information between the client device and the server ASR may also occur. As discussed in further detail below, a measure of the time lag from when the client ASR provides speech recognition results until the server ASR returns results to the client device may be used, at least in part, to determine how to provide visual feedback during a speech processing session in accordance with some embodiments.

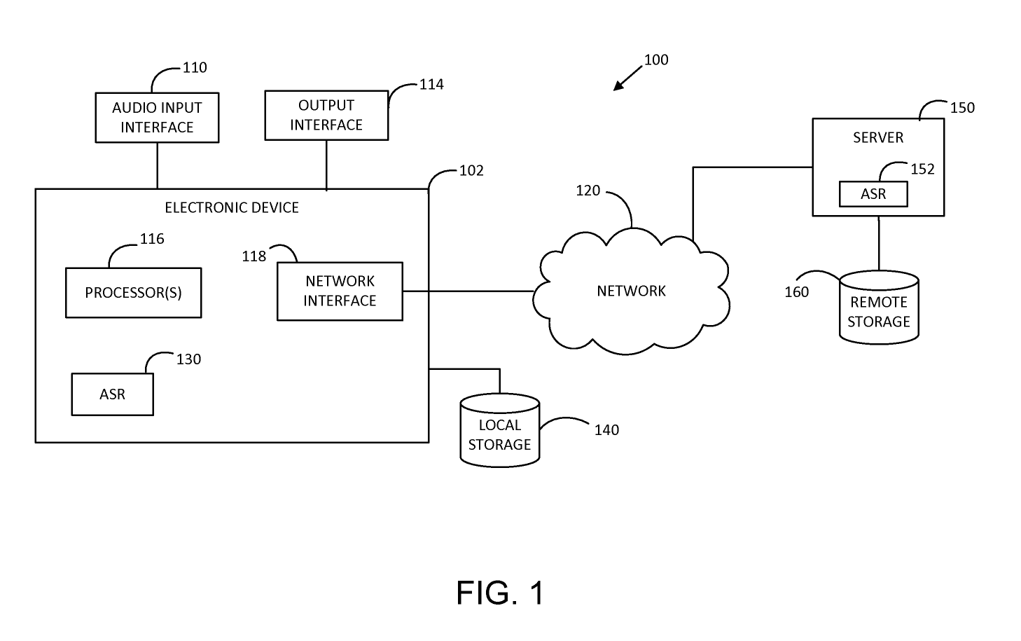

A client/server speech recognition system 100 that may be used in accordance with some embodiments of the invention is illustrated in FIG. 1. Client/server speech recognition system 100 includes an electronic device 102 configured to receive audio information via audio input interface 110. The audio input interface may include a microphone that, when activated, receives speech input, and the system may perform automatic speech recognition (ASR) based on the speech input. The received speech input may be stored in a datastore (e.g., local storage 140) associated with electronic device 102 to facilitate the ASR processing. Electronic device 102 may also include one or more other user input interfaces (not shown) that enable a user to interact with electronic device 102. For example, the electronic device may include a keyboard, a touch screen, and one or more buttons or switches connected to electronic device 102.

Electronic device 102 also includes output interface 114 configured to output information from the electronic device. The output interface may take any form, as aspects of the invention are not limited in this respect. In some embodiments, output interface 114 may include multiple output interfaces each configured to provide one or more types of output. For example, output interface 114 may include one or more displays, one or more speakers, or any other suitable output device. Applications executing on electronic device 102 may be programmed to display a user interface to facilitate the performance of one or more actions associated with the application. As discussed in more detail below, in some embodiments visual feedback provided in response to speech input is presented on a user interface displayed on output interface 114.

Electronic device 102 also includes one or more processors 116 programmed to execute a plurality of instructions to perform one or more functions on the electronic device. Exemplary functions include, but are not limited to, facilitating the storage of user input, launching and executing one or more applications on electronic device 102, and providing output information via output interface 114. Exemplary functions also include performing speech recognition (e.g., using ASR engine 130).

Electronic device 102 also includes network interface 118 configured to enable the electronic device to communicate with one or more computers via network 120. For example, network interface 118 may be configured to provide information to one or more server devices 150 to perform ASR, a natural language understanding (NLU) process, both ASR and an NLU process, or some other suitable function. Server 150 may be associated with one or more non-transitory datastores (e.g., remote storage 160) that facilitate processing by the server. Network interface 118 may be configured to open a network socket in response to receiving an instruction to establish a network connection with remote ASR engine(s) 152.

As illustrated in FIG. 1, remote ASR engine(s) 152 may be connected to one or more remote storage devices 160 that may be accessed by remote ASR engine(s) 152 to facilitate speech recognition of the audio data received from electronic device 102. In some embodiments, remote storage device(s) 160 may be configured to store larger speech recognition vocabularies and/or more complex speech recognition models than those employed by embedded ASR engine 130, although the particular information stored by remote storage device(s) 160 does not limit embodiments of the invention. Although not illustrated in FIG. 1, remote ASR engine(s) 152 may include other components that facilitate recognition of received audio including, but not limited to, a vocoder for decompressing the received audio and/or compressing the ASR results transmitted back to electronic device 102. Additionally, in some embodiments remote ASR engine(s) 152 may include one or more acoustic or language models trained to recognize audio data received from a particular type of codec, so that the ASR engine(s) may be particularly tuned to receive audio processed by those codecs.

Network 120 may be implemented in any suitable way using any suitable communication channel(s) enabling communication between the electronic device and the one or more computers. For example, network 120 may include, but is not limited to, a local area network, a wide area network, an Intranet, the Internet, wired and/or wireless networks, or any suitable combination of local and wide area networks. Additionally, network interface 118 may be configured to support any of the one or more types of networks that enable communication with the one or more computers.

In some embodiments, electronic device 102 is configured to process speech received via audio input interface 110, and to produce at least one speech recognition result using ASR engine 130. ASR engine 130 is configured to process audio including speech using automatic speech recognition to determine a textual representation corresponding to at least a portion of the speech. ASR engine 130 may implement any type of automatic speech recognition to process speech, as the techniques described herein are not limited to the particular automatic speech recognition process(es) used. As one non-limiting example, ASR engine 130 may employ one or more acoustic models and/or language models to map speech data to a textual representation. These models may be speaker independent or one or both of the models may be associated with a particular speaker or class of speakers. Additionally, the language model(s) may include domain-independent models used by ASR engine 130 in determining a recognition result and/or models that are tailored to a specific domain. Some embodiments may include one or more application-specific language models that are tailored for use in recognizing speech for particular applications installed on the electronic device. The language model(s) may optionally be used in connection with a natural language understanding (NLU) system configured to process a textual representation to gain some semantic understanding of the input, and output one or more NLU hypotheses based, at least in part, on the textual representation. ASR engine 130 may output any suitable number of recognition results, as aspects of the invention are not limited in this respect. In some embodiments, ASR engine 130 may be configured to output N-best results determined based on an analysis of the input speech using acoustic and/or language models, as described above.

Client/server speech recognition system 100 also includes one or more remote ASR engines 152 connected to electronic device 102 via network 120. Remote ASR engine(s) 152 may be configured to perform speech recognition on audio received from one or more electronic devices such as electronic device 102 and to return the ASR results to the corresponding electronic device. In some embodiments, remote ASR engine(s) 152 may be configured to perform speech recognition based, at least in part, on information stored in a user profile. For example, a user profile may include information about one or more speaker dependent models used by remote ASR engine(s) to perform speech recognition.

In some embodiments, audio transmitted from electronic device 102 to remote ASR engine(s) 152 may be compressed prior to transmission to ensure that the audio data fits in the data channel bandwidth of network 120. For example, electronic device 102 may include a vocoder that compresses the input speech prior to transmission to server 150. The vocoder may be a compression codec that is optimized for speech or take any other form. Any suitable compression process, examples of which are known, may be used and embodiments of the invention are not limited by the use of any particular compression method (including using no compression).

Rather than relying exclusively on the embedded ASR engine 130 or the remote ASR engine(s) 152 to provide the entire speech recognition result for an audio input (e.g., an utterance), some embodiments of the invention use both the embedded ASR engine and the remote ASR engine to process portions or all of the same input audio, either simultaneously or with the ASR engine(s) 152 lagging due to initial connection/startup delays and/or transmission time delays for transferring audio and speech recognition results across the network. The results of multiple recognizers may then be combined to facilitate speech recognition and/or to update visual feedback displayed on a user interface of the electronic device.

In the illustrative configuration shown in FIG. 1, a single electronic device 102 and remote ASR engine 152 is shown. However it should be appreciated that in some embodiments, a larger network is contemplated that may include multiple (e.g., hundreds or thousands or more) electronic devices serviced by any number of remote ASR engines. As one illustrative example, the techniques described herein may be used to provide an ASR capability to a mobile telephone service provider, thereby providing ASR capabilities to an entire customer base for the mobile telephone service provider or any portion thereof.

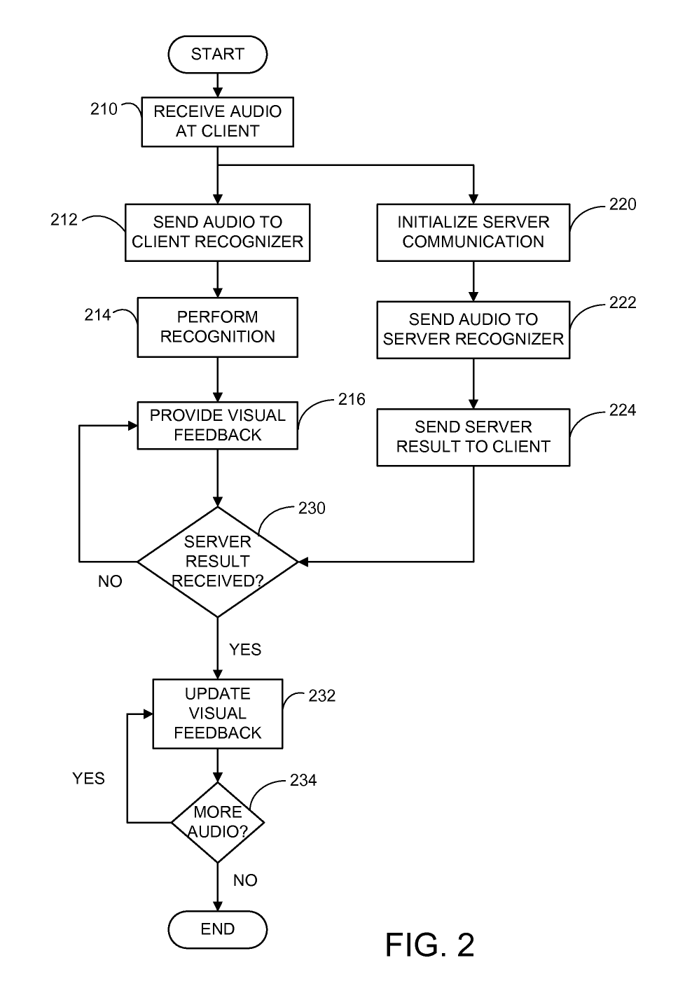

FIG. 2 shows an illustrative process for providing visual feedback on a user interface of an electronic device after receiving speech input in accordance with some embodiments. In act 210, audio comprising speech is received by a client device such as electronic device 102. Audio received by the client device may be split into two processing streams that are recognized by respective local and remote ASR engines of a hybrid ASR system, as described above. For example, after receiving audio at the client device, the process proceeds to act 212, where the audio is sent to an embedded recognizer on the client device, and in act 214, the embedded recognizer performs speech recognition on the audio to generate a local speech recognition result. After the embedded recognizer performs at least some speech recognition of the received audio to produce a local speech recognition result, the process proceeds to act 216, where visual feedback based on the local speech recognition result is provided on a user interface of the client device. For example, the visual feedback may be representation of the word(s) corresponding to the local speech recognition results. Using local speech recognition results to provide visual feedback enables the visual feedback to be provided to the user soon after speech input is received, thereby providing users with confidence that the system is working properly.

Audio received by the client device may also be sent to one or more server recognizers for performing cloud ASR. As shown in the process of FIG. 2, after receiving audio by the client device, the process proceeds to act 220, where a communication session between the client device and a server configured to perform ASR is initialized. Initialization of server communication may include a plurality of processes including, but not limited to, establishing a network connection between the client device and the server, validating the network connection, transferring user information from the client device to the server, selecting and loading a user profile for speech recognition by the server, and initializing and configuring the server ASR engine to perform speech recognition.

Following initialization of the communication session between the client device and the server, the process proceeds to act 222, where the audio received by the client device is sent to the server recognizer for speech recognition. The process then proceeds to act 224, where a remote speech recognition result generated by the server recognizer is sent to the client device. The remote speech recognition result sent to the client device may be generated based on any portion of the audio sent to the server recognizer from the client device, as aspects of the invention are not limited in this respect.

Returning to processing on the client device, after presenting visual feedback on a user interface of the client device based on a local speech recognition result in act 216, the process proceeds to act 230, where it is determined whether any remote speech recognition results have been received from the server. If it is determined that no remote speech recognition results have been received, the process returns to act 216, where the visual feedback presented on the user interface of the client device may be updated based on additional local speech recognition results generated by the client recognizer. As discussed above, some embodiments provide streaming visual feedback such that visual feedback based on speech recognition results is presented on the user interface during the speech recognition process. Accordingly, the visual feedback displayed on the user interface of the client device may continue to be updated as the client recognizer generates additional local speech recognition results until it is determined in act 230 that remote speech recognition results have been received from the server.

If it is determined in act 230 that speech recognition results have been received from the server, the process proceeds to act 232, where the visual feedback displayed on the user interface may be updated based, at least in part, on the remote speech recognition results received from the server. The process then proceeds to act 234, where it is determined whether additional input audio is being recognized. When it is determined that input audio continues to be received and recognized, the process returns to act 232, where the visual feedback continues to be updated until it is determined in act 234 that input audio is no longer being processed.

Updating the visual feedback presented on the user interface of client device may be based, at least in part, on the local speech recognition results, the remote speech recognition results, or a combination of the local speech recognition results and the remote speech recognition results. In some embodiments, the system may trust the accuracy of the remote speech recognition results more than the accuracy of the local speech recognition results, and visual feedback based only on the remote speech recognition results may be provided as soon as it becomes available. For example, as soon as it is determined that remote speech recognition results are received from the server the visual feedback based on the local ASR results and displayed on the user interface may be replaced with visual feedback based on the remote ASR results.

In some embodiments, the visual feedback may continue to be updated based only on the local speech recognition results even after speech recognition results are received from the server. For example, when remote speech recognition results are received by the client device, it may be determined whether the received remote speech recognition results lag behind the locally-recognized speech results, and if so, by how much the remote results lag behind. The visual feedback may then be updated based, at least in part, on how much the remote speech recognition results lag behind the local speech results. For example, if the remote speech recognition results include only results for a first word, whereas the local speech recognition results include results for the first four words, the visual feedback may continue to be updated based on the local speech recognition results until the number of words recognized in the remote speech recognition results is closer to the number of words recognized locally. In contrast to the above-described example where the visual feedback based on the remote speech recognition results is displayed as soon as the remote results are received by the client device, waiting to update the visual feedback based on the remote speech recognition results until the lag between the remote and local speech recognition results is small may lessen the perception by the user that the local speech recognition results were incorrect (e.g., by deleting visual feedback based on the local speech recognition results when remote speech recognition results are first received). Any suitable measure of lag may be used, and it should be appreciated that a comparison of the number of recognized words is provided merely as an example.

In some embodiments, updating the visual feedback displayed on the user interface may be performed based, at least in part, on a degree of matching between the remote speech recognition results and at least a portion of the locally-recognized speech. For example, the visual feedback displayed on the user interface may not be updated based on the remote speech recognition results until it is determined that there is a mismatch between the remote speech recognition results and at least a portion of the local speech recognition results. For illustration, if the local speech recognition results are “Call my mother,” and the received remote speech recognition results are “Call my,” the remote speech recognition results match at least a portion of the local speech recognition results, and the visual feedback based on the local speech recognition results may not be updated. By contrast, if the received remote speech recognition results are “Text my,” there is a mismatch between the remote speech recognition results and the local speech recognition results, and the visual feedback may be updated based, at least in part, on the remote speech recognition results. For example, display of the word “Call” may be replaced with the word “Text.” Updating the visual feedback displayed on the client device only when there is a mismatch between the remote and local speech recognition results may improve the user experience by only updating the visual feedback when necessary.

In some embodiments, receipt of the remote speech recognition results from the server may result in the performance of additional operations by the client device. For example, the client recognizer may be instructed to stop processing the input audio when it is determined that such processing is no longer necessary. A determination that local speech recognition processing is no longer needed may be made in any suitable way. For example, it may be determined that the local speech recognition processing is not needed immediately upon receipt of remote speech recognition results, after a lag time between the remote speech recognition results and the local speech recognition results is smaller than a threshold value, or in response to determining that the remote speech recognition results do not match at least a portion of the local speech recognition results. Instructing the client recognizer to stop processing input audio as soon as it is determined that such processing is no longer needed may preserve client resources (e.g., battery power, processing resources, etc.).

The above-described embodiments of the invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. An electronic device comprising:
an input interface configured to receive input audio comprising speech;
an embedded speech recognizer configured to process at least a portion of the input audio to produce local recognized speech;
a network interface configured to send at least a portion of the input audio to a network device remotely located from the electronic device for remote speech recognition; and
a user interface configured to display visual feedback based on at least a portion of the local recognized speech prior to receiving streaming recognition results from the network device.

2. The electronic device of claim 1, wherein the network interface is further configured to receive the streaming recognition results from the network device, and wherein the electronic device further comprises at least one processor programmed to update the visual feedback displayed on the user interface in response to receiving streaming recognition results from the network device.

3. The electronic device of claim 2, wherein updating the visual feedback displayed on the user interface comprises:
determining whether the streaming recognition results received from the network device lag behind the local recognized speech; and
continuing to display visual feedback based on at least a portion of the local recognized speech when it is determined that the streaming recognition results received from the network device lag behind the local recognized speech.

4. The electronic device of claim 2, wherein updating the visual feedback displayed on the user interface comprises updating the visual feedback to display visual feedback based on the streaming recognition results received from the network device.

5. The electronic device of claim 4, wherein the embedded speech recognizer is further configured to stop processing the input audio in response to receiving the streaming recognition results from the network device.

6. The electronic device of claim 2, wherein updating the visual feedback displayed on the user interface comprises:
determining whether the streaming recognition results received from the network device match at least a portion of the local recognized speech; and
updating the visual feedback to display visual feedback based on the streaming recognition results received from the network device when it is determined that the streaming recognition results received from the network device do not match at least a portion of the local recognized speech.

7. The electronic device of claim 6, wherein updating the visual feedback to display visual feedback based on the streaming recognition results received from the network device comprises replacing at least one first word displayed as visual feedback based on the local recognized speech with at least one second word included in the streaming recognition results received from the network device.

8. A method of providing visual feedback on an electronic device, the method comprising:
processing, by an embedded speech recognizer of the electronic device, at least a portion of input audio comprising speech to produce local recognized speech;
sending at least a portion of the input audio to a network device remotely located from the electronic device for remote speech recognition; and
displaying, on a user interface of the electronic device, visual feedback based on at least a portion of the local recognized speech prior to receiving streaming recognition results from the network device.

9. The method of claim 8, further comprising:
receiving the streaming recognition results from the network device; and
updating the visual feedback displayed on the user interface in response to receiving the streaming recognition results from the network device.

10. The method of claim 9, wherein updating the visual feedback displayed on the user interface comprises:
determining whether the streaming recognition results received from the network device lag behind the local recognized speech; and
continuing to display visual feedback based on at least a portion of the local recognized speech when it is determined that the streaming recognition results received from the network device lag behind the local recognized speech.

11. The method of claim 9, wherein updating the visual feedback displayed on the user interface comprises updating the visual feedback to display visual feedback based on the streaming recognition results received from the network device.

12. The method of claim 11, further comprising stopping processing the input audio in response to receiving the streaming recognition results from the network device.

13. The method of claim 9, wherein updating the visual feedback displayed on the user interface comprises:
determining whether the streaming recognition results received from the network device match at least a portion of the local recognized speech; and
updating the visual feedback to display visual feedback based on the streaming recognition results received from the network device when it is determined that the streaming recognition results received from the network device do not match at least a portion of the local recognized speech.

14. The method of claim 13, wherein updating the visual feedback to display visual feedback based on the streaming recognition results received from the network device comprises replacing at least one first word displayed as visual feedback based on the local recognized speech with at least one second word included in the streaming recognition results received from the network device.

15. A non-transitory computer-readable medium encoded with a plurality of instructions that, when executed by at least one computer processor of an electronic device, perform a method, the method comprising:
processing, by an embedded speech recognizer of the electronic device, at least a portion of input audio comprising speech to produce local recognized speech;
sending at least a portion of the input audio to a network device remotely located from the electronic device for remote speech recognition; and
displaying, on a user interface of the electronic device, visual feedback based on at least a portion of the local recognized speech prior to receiving streaming recognition results from the network device.

16. The computer-readable medium of claim 15, wherein the method further comprises:
receiving the streaming recognition results from the network device; and
updating the visual feedback displayed on the user interface in response to receiving the streaming recognition results from the network device.

17. The computer-readable medium of claim 16, wherein updating the visual feedback displayed on the user interface comprises:
determining whether the streaming recognition results received from the network device lag behind the local recognized speech; and
continuing to display visual feedback based on at least a portion of the local recognized speech when it is determined that the streaming recognition results received from the network device lag behind the local recognized speech.

18. The computer-readable medium of claim 16, wherein updating the visual feedback displayed on the user interface comprises updating the visual feedback to display visual feedback based on the streaming recognition results received from the network device.

19. The computer-readable medium of claim 16, wherein updating the visual feedback displayed on the user interface comprises:
determining whether the streaming recognition results received from the network device match at least a portion of the local recognized speech; and
updating the visual feedback to display visual feedback based on the streaming recognition results received from the network device when it is determined that the streaming recognition results received from the network device do not match at least a portion of the local recognized speech.

20. The computer-readable medium of claim 19, wherein updating the visual feedback to display visual feedback based on the streaming recognition results received from the network device comprises replacing at least one first word displayed as visual feedback based on the local recognized speech with at least one second word included in the streaming recognition results received from the network device.
